(19) United States
(12) Patent Application Publication
(10) Pub. No.: US 2010/0068915 A1
(43) Pub. Date: Mar. 18, 2010

(54) Electrical Contact Between a Terminal Pin and a Terminal Wire and Method for Producing Said Contact

(75) Inventor: Soeren Kahl, Finspong (SE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/308,201

(22) PCT Filed: Jul. 30, 2007
(86) PCT No.: PCT/EP2007/057835

§ 371 Date: Oct. 22, 2009

(30) Foreign Application Priority Data
Aug. 30, 2006 (DE) 10 2006 040 652.4

(51) Int. Cl. H01R 4/26; H01R 43/20

(52) U.S. Cl. 439/391; 29/876

(57) ABSTRACT

An electrical contact between a terminal pin and a terminal wire is produced by the pin having an edge against which the wire, inclusive of the insulating jacket on the wire, is radially pressed. The radial contact force is generated via a contact part which encompasses the terminal pin.

### BACKGROUND OF THE INVENTION

1. Field of the Invention

The present invention relates to an electrical contact between a terminal pin and a terminal wire that is to be connected, as well as to a method for producing an electrical connection between a terminal pin and a terminal wire.

2. Description of Related Art

Published German patent document DE 30 46 630 describes an electrical printed-circuit board having several terminal pins arranged at a distance from one another, which project perpendicularly from the printed-circuit board and are each connected electrically to a terminal wire. For this purpose, the terminal wire is wound around the terminal pin, the electrical contact between pin and wire being produced according to wire-wrap connection technique, in which the terminal wire is wound around the pin using such a great longitudinal tension that a sharp-edged corner on the terminal pin enters into a cold-welded, electrically conductive connection with the wire.

However, the assumption for carrying out the wire-wrap method is the prior stripping of the terminal wire as well as using special winding tools for winding the terminal wire around the terminal pin, using the required tensile stress.

### BRIEF SUMMARY OF THE INVENTION

An object of the present invention is to provide an electrically conductive connection between a terminal pin and a terminal wire, using simple measures and without supplying heat.

According to a first aspect of the present invention, the electrically conductive connection between the terminal pin and the terminal wire, which is provided with an electrical insulation, takes place in that the terminal wire including its insulating jacket, that is, without the insulation being removed, is wound around the terminal pin which has an edge, so that the wire winding lies directly against this edge. Furthermore, a contact part is provided which encompasses the terminal pin in the area of the wire winding, and exerts a radial contact force on the wire winding, the radial contact force being directed inwards, in the direction towards the terminal pin. In this way, the wire winding has applied to it a radial contact force directed from the outside towards the inside, and it is pressed against the edge on the outer jacket of the terminal pin, whereby the insulating jacket is damaged and the conductive core in the wire comes into direct contact with the conductive terminal pin. In some instances, based on the continuous high contact pressure, cold welding between the wire and the surface area of the pin is achieved in the area of the contact locations. A sufficient contact normal force is generated upon the contact part over the service life of the product, which ensures the electrically conductive contact between the wire and the pin.

According to a second aspect of the present invention, which relates to the method for producing the electrically conductive connection, the terminal wire including its electrical insulating jacket is first wound around the edge on the terminal pin, and then the contact part is placed around the wire winding on the terminal pin, and via this contact part, a contact force is generated that acts radially in the direction onto the terminal pin. According to one advantageous specific embodiment, this takes place in such a way that the contact part is pushed axially onto the terminal pin, the wire winding being able to be pressed radially against the terminal pin already during the push-on process. In this situation it may be expedient that the wire winding is displaced axially during being pushed on, so that the sharp edge on the terminal pin cuts through the insulating jacket. Because of this cutting motion, the insulating jacket is cut through, so that the wire comes into direct contact with the surface area at the edge of the pin.

According to one alternative example embodiment, one may however do without the shifting of the wire winding; in this case, the cutting through of the insulating jacket on the terminal wire takes place only because of the static pressure that is exerted in the radial direction by the contact part.

If the contact part is developed so that the radial pressure is already being exerted upon the pushing on of the contact part, then expediently at least one section of the contact part, which is preferably developed as a sleeve, has an inside diameter which is less than at least one section of the wire winding laid around the pin, so that the radial contact force is generated just by the pushing on of the contact sleeve. This may even be supported by a conical internal geometry of the contact part, which, for one thing, enables an easier mounting of the contact part onto the end face of the pin, and for another thing, automatically effects an increased radial pressing-on with increasing axial pushing on. The conical shape additionally has the advantage that the degree of the axial pushing on determines the magnitude of the radial contact force.

A further alternative to be considered is a sleeve that is slitted in the longitudinal direction, which may be opened radially based on its spring action, and then exerts a pressure directed radially inwards.

According to another example embodiment, the contact part is also developed pot-shaped, i.e. a base is provided that limits the pushing on of the contact part onto the end face of the pin.

According to an alternative example embodiment it may, however, also be expedient to develop the contact part to have a diameter that is greater than the wire winding, and to push it onto the pin that has the wire winding. Only after the contact part has reached the desired axial position is it compressed mechanically, and is thereby pressed radially against the wire winding.

In order to minimize frictional forces, which could occur between the inner wall of the contact part and the insulating jacket surrounding the terminal wire, in response to the mounting of the contact part, it may be advantageous to provide the inner wall of the contact part with a friction-minimizing coating. Using a lubricant would also be possible, particularly one that is based on an organic material.

### BRIEF DESCRIPTION OF THE SEVERAL VIEWS OF THE DRAWING

FIG. 1 shows a view of a terminal pin around which a terminal wire is wound which is to be electrically connected to the terminal pin, a sleeve-shaped contact part being pressed onto the end face of the terminal pin, whereby the wire winding is pressed radially against the edges of the pin, which is square in cross section.

FIG. 2 shows a section through the terminal pin, including the wire winding and the mounted contact part.

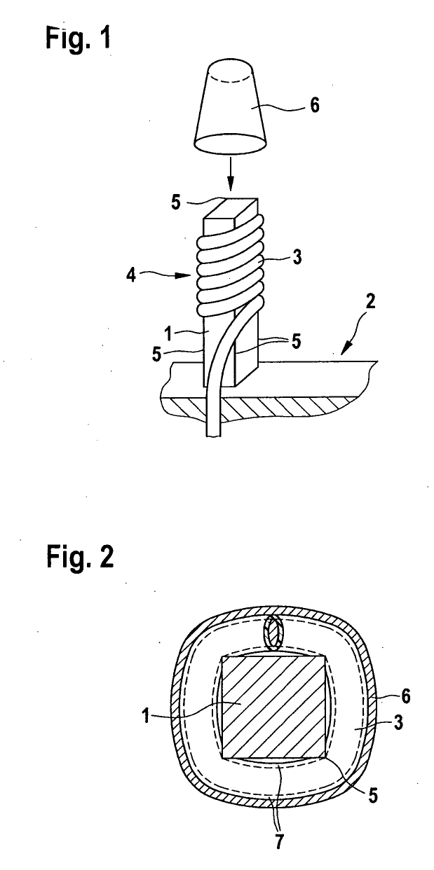

### DETAILED DESCRIPTION OF THE INVENTION

In the exemplary embodiment shown in the figures, a terminal pin 1 is involved, that is made of an electrically conductive material and is a component of an electrical component 2, for instance, a coil holder or the like, and which is to be electrically connected to a terminal wire 3 which branches off from a coil winding that is not shown. Electrical terminal wire 3, inclusive of its insulating jacket, is laid around the surface area of terminal pin 1, and forms a wire winding 4. In order to produce an electrical contact between the terminal wire and terminal pin 1, and also to ensure a durable contact over the service life of the component, the core of terminal wire 3 is constantly pressed against terminal pin 1, without adding heat. In this context, cold welding may occur. Terminal pin 1 has a rectangular cross section, a square one in particular, and has a total of four sharp edges 5, against which the core of terminal wire 3 lies in electrically conductive contact.

This electrical contact is produced by mechanical joining. To produce this, a sleeve-shaped and conical contact part 6 is mounted onto the end face of terminal pin 1 under pressure or tension. During the axial pushing on of contact part 6, this part, because of its conical shape, exerts an increasing contact pressure, that is directed radially inwards, on wire winding 4, so that it is pressed against the surface area, and particularly against edges 5, of the terminal pin. Terminal wire 3 has an insulating jacket 7, which in the case of coil wire is expediently made of an insulating enamel layer, and which is damaged, or rather, cut through, by the radial contact pressure in the vicinity of relatively sharp edges 5. The contact force generated by contact part 6 is great enough for insulating jacket 7 to be cut through, and for the edges to penetrate into the core of terminal wire 3. Because of the continuing pressure generated by contact part 6, a durable electrical connection is created between edges 5 of terminal pin 1 and the core of terminal wire 3.

In this instance it may be expedient to select contact part 6 and terminal pin 1 in such a way that wire winding 4 is at least partially axially displaced by the mounting of the contact part, this displacing motion resulting in the cutting through of insulating jacket 7 along edge 5. The axial displacement of wire winding 4 along the surface area of terminal wire pin 1 may be limited by a stop on the terminal pin, for instance, an encircling shoulder or the like.

As an additional alternative, a sleeve having a longitudinal slit may be provided. The advantage of the slitted sleeve is that the sleeve is able to exert a radial pressure force on inside diameters over a greater range than a sleeve that is not slitted, because the slitted sleeve has a lesser stiffness. However, the maximum radial pressure force is greater in the case of the sleeve that is not slitted.

In the method for producing an electrical connection between the terminal pin and the terminal wire, the slitted sleeve is bent open in its elastically springy region, is pushed loosely over the wire winding and is then partially relaxed, so that the sleeve presses the wire radially onto the edges of the terminal pin.

The methods described for the sleeve that is not slitted, for producing the electrical contact, are basically also applicable using the slitted sleeve.

According to one additional alternative embodiment, it is provided that the dimensioning and the form of contact part 6 are selected so that it is able to be mounted on the pin, inclusive of wire winding 4, without generating a radial contact force. The radial contact force is achieved only after the final axial position is reached, by mechanically compressing contact part 6 and pressing it against the terminal pin and wire winding 4.

Within the scope of the present invention, one may consider all possible cross sectional shapes for terminal pin 1, and if necessary, the shape of contact part 6 may have to be adapted to the cross sectional shape of terminal pin 1.

In order to secure contact part 6 durably to the terminal pin, it may be expedient to provide a fixing to the pin at the lower edge of the contact part, that is, at the edge facing away from the end face of the pin.

1-15. (canceled)

16. An electrical contact arrangement, comprising:
a terminal pin;
a terminal wire having an insulation jacket, wherein the terminal wire is wound around an end portion of the terminal pin; and
a contact part applied axially onto the terminal wire wound around the end portion of the terminal pin, wherein the contact part applies a radial contact force to the wound wire in the direction towards the terminal pin, and wherein the radial contact force results in at least a segment of the end portion of the terminal pin cutting through the insulation jacket and contacting the terminal wire to produce an electrically conductive connection.

17. The contact arrangement as recited in claim 16,
wherein the contact part is configured as a sleeve.

18. The contact arrangement as recited in claim 17, wherein the sleeve has a longitudinal slit.

19. The contact arrangement as recited in claim 16,
wherein the inner geometry of contact part has a conical shape.

20. The contact arrangement as recited in claim 16,
wherein the contact part is pot-shaped and positioned over a free end face of the terminal pin.

21. The contact arrangement as recited in claim 19,
wherein a radial contact force of varying magnitude acts over the axial length of the contact part.

22. The contact arrangement as recited in claim 19,
wherein the terminal pin includes a stop for axially securing the terminal wire wound around the pin.

23. The contact arrangement as recited in claim 19,
wherein the inner wall of contact part is provided with a friction-reducing coating.

24. The contact arrangement as recited in claim 23,
wherein the insulating jacket of the terminal wire is enamel.

25. The contact arrangement as recited in claim 23,
wherein the terminal pin has a rectangular cross section.

26. A method for producing an electrical connection between a terminal pin of an electrical component and a terminal wire, comprising:
providing an electrical insulating jacket for the terminal wire;
winding the terminal wire having the electrical insulating jacket around an end portion of the terminal pin;
mounting a contact part axially onto the terminal wire wound around the end portion of the terminal pin, wherein the contact part applies a radial contact force to the wound wire in the direction towards the terminal pin, and wherein the radial contact force results in at least a segment of the end portion of the terminal pin cutting through the insulation jacket and contacting the terminal wire to produce an electrically conductive connection.

27. The method as recited in claim 26, wherein the wire winding is displaced axially during the mounting of the contact part onto the terminal wire.

28. The method as recited in claim 26, wherein the contact part is radially elastic so as to apply radial pressure against the terminal pin after mounting, due to internal elastic stress of the contact part.

29. The method as recited in claim 26, wherein the mounting of the contact part includes positioning the contact part over the terminal pin at a desired axial position and applying radial pressure by mechanical compression.
